(19) United States
(12) Patent Application Publication
(10) Pub. No.: US 2025/0177993 A1
(43) Pub. Date: Jun. 5, 2025

(54) MONITORING METHOD FOR ROLL GAP BETWEEN GRINDING ROLLERS OF FLOUR MILL

(71) Applicant: BUHLER (WUXI) COMMERCIAL CO., LTD., Wuxi New District Wuxi (CN)

(72) Inventors: Jun SHI, Jiangsu (CN); Honghui ZHANG, Jiangsu (CN); Xiaobo LI, Jiangsu (CN)

(21) Appl. No.: 18/843,141

(22) PCT Filed: Mar. 1, 2023
(86) PCT No.: PCT/CN2023/079048

§ 371 Date: Aug. 30, 2024

(30) Foreign Application Priority Data
Mar. 8, 2022 (CN) 202210232444.2

(51) Int. Cl. B02C 4/38; B02C 4/06

(52) U.S. Cl. CPC B02C 4/38; B02C 4/06

(57) ABSTRACT

A monitoring method for a roll gap between grinding rollers of a flour mill, comprising: providing a control unit and a roll gap adjusting mechanism. The control unit has a data collection module and a storage processing module, and a roll gap initial value is preset in the storage processing module; the roll gap adjusting mechanism at least comprises an adjusting screw rod and a position detection unit, and the position detection unit detects a rotation change of the adjusting screw rod and sends position detection data to the data collection module; the data collection module converts the position detection data into a roll gap change value and sends the roll gap change value to the storage processing module, and the storage processing module obtains a current roll gap value according to the roll gap initial value and the roll gap change value.

### TECHNICAL FIELD

The present invention relates generally to the technical field of flour mills and, particularly, to a monitoring method for a roll gap between grinding rollers of a flour mill.

### BACKGROUND

A flour mill is an important flour milling apparatus, and generally consists of five components, i.e., grinding rollers, a feeding mechanism, a roll gap adjusting mechanism, a transmission mechanism, and a grinding roller cleaning mechanism.

The roll gap adjusting mechanism is a very important component in the flour mill. Roll gap adjustment is the movement of two grinding rollers closer to or away from each other to change the distance between the two grinding rollers.

When the roll gap is decreased, the grinding pressure applied by the two grinding rollers to the material is increased, and a grinding region can be lengthened, so that the number of breaking teeth can be increased, and the grain size of the material having passed by the grinding rollers is smaller, thereby increasing the break release and the flour extraction rate. Conversely, when the roll gap is increased, both the break release and the flour extraction rate are decreased.

In the existing designs, most roll gap adjusting mechanisms are manual adjusting mechanisms. For the manual adjusting mechanism, the actual roll gap change value is only controlled by means of the roll gap gauge provided on the hand wheel, so that a technician cannot accurately learn the precise roll gap value in real time, and it is difficult to ensure stability of flour milling quality and to optimize flour milling parameters.

### SUMMARY

An objective of the present invention is to overcome the above defects in the prior art and to provide a monitoring method for a roll gap between grinding rollers of a flour mill. The monitoring method accurately reflects an actual change value of a roll gap.

The present invention provides the following technical solution:

A monitoring method for a roll gap between grinding rollers of a flour mill, comprising:
providing a control unit and a roll gap adjusting mechanism,
the control unit having a data collection module and a storage processing module, and a roll gap initial value being preset in the storage processing module;

the roll gap adjusting mechanism at least comprising an adjusting screw rod and a position detection unit, and the position detection unit detecting a rotation change of the adjusting screw rod and sending position detection data to the data collection module;
the data collection module converting the position detection data into a roll gap change value and sending the roll gap change value to the storage processing module, and the storage processing module obtaining a current roll gap value according to the roll gap initial value and the roll gap change value, and storing the roll gap change value and the current roll gap value in real time.

According to the above technical idea, the present invention may further comprise any one or more of the following optional forms.

In some optional forms, the control unit further has an input/output module, and the input/output module communicates with the storage processing module to set or read data in the storage processing module.

In some optional forms, the input/output module comprises a display, and the display displays the roll gap change value and the current roll gap value in real time.

In some optional forms, the position detection unit detects the rotation change of the adjusting screw rod during power-on and power-off of the flour mill.

In some optional forms, the monitoring method further comprises: after the flour mill operates for each cycle, measuring a wear value of each grinding roller, and setting the wear value in the storage processing module by means of the input/output module, so that the storage processing module obtains a corrected roll gap value according to the current roll gap value and the wear value.

In some optional forms, the position detection unit is directly mounted at a middle portion of the adjusting screw rod.

In some optional forms, the position detection unit is connected to the adjusting screw rod by means of a belt transmission mechanism, and the belt transmission mechanism rotates in synchronization with the adjusting screw rod.

In some optional forms, the position detection unit is provided at either one of two ends of the adjusting screw rod.

In some optional forms, the position detection unit is connected to the end of the adjusting screw rod by means of a direction changing coupling or a flexible shaft.

In some optional forms, the position detection unit is connected to the adjusting screw rod by means of a nut, and the nut translates along the adjusting screw rod as the adjusting screw rod rotates.

In some optional forms, the position detection unit comprises a sensing ring and a sensing arm, the sensing ring rotating in synchronization with the adjusting screw rod, and the sensing arm being used to detect rotation of the sensing ring.

In the monitoring method of the present invention, an actual change of the roll gap between the grinding rollers of the flour mill can be monitored in real time, and the storage processing module stores the roll gap change value and the current roll gap value. The stored data can be subjected to numerical analysis to optimize parameters of the flour mill, thereby facilitating optimization of a flour milling process.

### BRIEF DESCRIPTION OF THE DRAWINGS

Other features and advantages of the present invention will be better understood by means of optional embodiments described in detail below with reference to the accompanying drawings, and in the accompanying drawings, the same reference numerals indicate the same or similar components. In the accompanying drawings:

FIG. 1 shows a schematic structural diagram of a flour mill according to an embodiment of the present invention;

FIG. 2 shows a roll gap adjusting mechanism in FIG. 1, the roll gap adjusting mechanism including Embodiment 1 of a position detection unit;

FIG. 3 shows a roll gap adjusting mechanism including Embodiment 2 of a position detection unit;

FIG. 4 shows a roll gap adjusting mechanism including Embodiment 3 of a position detection unit;

FIG. 5 shows a roll gap adjusting mechanism including Embodiment 4 of a position detection unit;

FIG. 6 shows a roll gap adjusting mechanism including Embodiment 5

of a position detection unit;

FIG. 7 shows a roll gap adjusting mechanism including Embodiment 6 of a position detection unit; and

FIG. 8 shows a schematic diagram of a control unit according to an embodiment of the present invention.

It should be understood by those skilled that elements in the accompanying drawings are shown for simplicity and clarity, and are not necessarily drawn to scale. For example, the dimensions of some elements in the accompanying drawings may be exaggerated relative to other elements to help improve understanding of the embodiments of the present disclosure.

### DETAILED DESCRIPTION

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art on the basis of the embodiments of the present invention without the exercise of inventive effort shall fall within the scope of protection of the present invention.

In the present specification, the terms “first to sixth” are not used to define the order and the number of components unless otherwise specified.

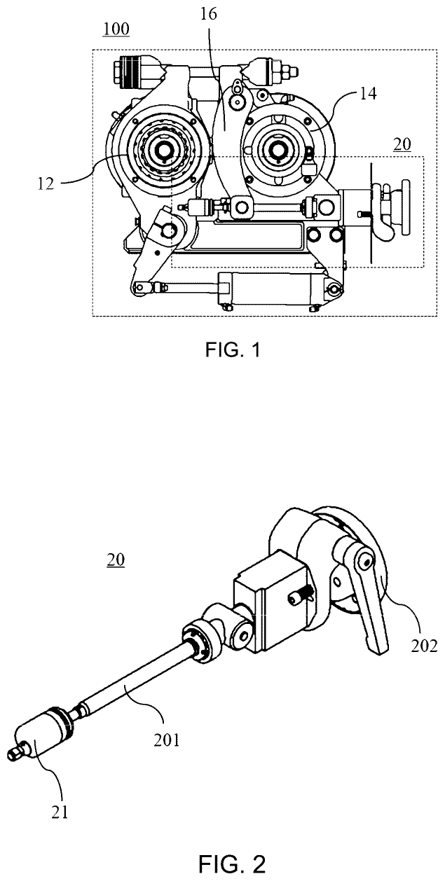

In an exemplary embodiment, as shown in FIG. 1, a flour mill 100 includes a floating grinding roller 12, a fixed grinding roller 14, and a roll gap adjusting mechanism 20. The roll gap adjusting mechanism 20 is connected to the floating grinding roller 12 by means of a transmission mechanism to adjust a roll gap between the floating grinding roller 12 and the fixed grinding roller 14. The transmission mechanism includes, for example, a connecting rod 16. Specifically, referring to FIG. 2, the connecting rod 16 is connected to an adjusting screw rod 201 of the roll gap adjusting mechanism 20. It should be understood that the transmission mechanism between the roll gap adjusting mechanism 20 and the floating grinding roller 12 may be any known transmission mechanism for converting rotation of the adjusting screw rod 201 into displacement of the floating grinding roller 12. Therefore, a rotation change amount of the adjusting screw rod 201 is directly correlated with a roll gap change value between the floating grinding roller 12 and the fixed grinding roller 14, and by using such a direct correlation, the present invention provides a position detection unit for the roll gap adjusting mechanism.

Specifically, in Embodiment 1 shown in FIG. 2, the adjusting screw rod 201 of the roll gap adjusting mechanism 20 is driven by means of a hand wheel 202. The roll gap adjusting mechanism 20 is further provided with a first position detection unit 21 used to detect a rotation change of the adjusting screw rod 201.

By using the first position detection unit 21, the present invention provides a monitoring method for a roll gap. In the method, a control unit 30 is provided for the first position detection unit 21. Referring to FIG. 8, the control unit 30 has a data collection module 301 and a storage processing module 302. A roll gap initial value M1 is preset in the storage processing module 302. The first position detection unit 21 detects the rotation change of the adjusting screw rod 201 (e.g., a positive rotation change amount or a negative rotation change amount of a rotation angle of the adjusting screw rod 201) and sends position detection data to the data collection module 301. The data collection module 301 converts the position detection data into a roll gap change value M2 (a positive value or a negative value) and sends the roll gap change value M2 to the storage processing module 302. The storage processing module 302 obtains (calculates) a current roll gap value M3 according to the preset roll gap initial value M1 and the roll gap change value M2, where M3=M1+M2, and the storage processing module 302 stores the roll gap change value M2 and the current roll gap value M3 in real time.

In an optional embodiment, the control unit 30 further has an input/output module 303, and the input/output module 303 communicates with the storage processing module 302 to set or read data in the storage processing module 302. In an aspect, the roll gap initial value M1 may be preset in the storage processing module 302 by means of the input/output module 303. The roll gap initial value M1 is determined at the time of factory shipment of the flour mill, or is determined by means of measurement means such as a feeler gauge after the flour mill operates for each period of time. That is, the roll gap initial value M1 may be preset again by means of the input/output module 303. In another aspect, the input/output module 303 reads data in the storage processing module 302 in real time, and the data includes the roll gap change value M2 and the current roll gap value M3 stored by the storage processing module 302. Preferably, the input/output module 303 includes a display, and the display displays in real time the roll gap change value M2 and the current roll gap value M3 read thereby. In this way, when, for example, manually driving the adjusting screw rod 201 to rotate, a technician can intuitively learn the magnitude of the value of the roll gap adjusted thereby, so as to determine the magnitude of coarse adjustment or fine adjustment performed thereby. In addition, after the roll gap is adjusted for a period of time, historical data in the storage processing module 302 is read by means of the input/output module 303, and the read historical data is subjected to numerical analysis to optimize parameters of the flour mill, thereby further facilitating optimization of the flour milling process.

Notably, the position detection unit detects the rotation change of the adjusting screw rod 201 during power-on and power-off of the flour mill 100. In other words, the storage processing module 302 of the control unit 30 stores the current roll gap value M3 before the flour mill is powered off. During power-off, a rotation change amount of the adjusting screw rod may be generated due to an unintentional touch or an intentional adjustment. Such a rotation change amount can be captured by the position detection unit. Once the flour mill is powered on again, the data collection module 301 immediately receives data generated by the position detection unit during the power-off, converts the data into a roll gap change value, and sends the roll gap change value to the storage processing module 302, so that the storage processing module 302 always stores the actual current roll gap value M3.

In the case that wear of the grinding roller is not considered, it can be considered that in the monitoring method for a roll gap of the present invention, the actual change value of the roll gap is monitored in real time. In a preferred embodiment, the rotation change amount of the adjusting screw rod is considered in combination with a wear amount of the grinding roller, thereby obtaining a more precise actual change value of the roll gap. This is because the floating grinding roller 12 and the fixed grinding roller 14 each include a rotating shaft and a grinding body provided on the rotating shaft. An adjustment of the roll gap between the floating grinding roller 12 and the fixed grinding roller 14 is essentially an adjustment of the distance between the respective rotating shafts of the floating grinding roller 12 and the fixed grinding roller 14. In the case that wear of the grinding rollers is not considered, it can be considered that a change of the distance between the respective grinding bodies of the floating grinding roller 12 and the fixed grinding roller 14 is equal to the change of the roll gap. However, after the grinding rollers are used for a certain period of time, wear necessarily occurs. That is, radii of the respective grinding bodies of the floating grinding roller 12 and the fixed grinding roller 14 are decreased to different extents. In this case, the change of the distance between the respective grinding bodies should be considered by combining the change of the distance between the respective rotating shafts and the change of the radii of the respective grinding bodies.

In this regard, the monitoring method for a roll gap of the present disclosure further includes: after the flour mill 100 operates for each cycle, measuring a wear value of each grinding roller (including the floating grinding roller 12 and the fixed grinding roller 14), so that after the wear value of each grinding roller is obtained, the technician can set the wear value of each grinding roller in the storage processing module 302 by means of the input/output module 303 of the control unit 30, and the storage processing module 302 obtains (calculates) a corrected roll gap value according to the current roll gap value and the wear values, the corrected roll gap value being an actual roll gap value. According to the aforementioned method for obtaining the current roll gap value, it is assumed that: the current roll gap value is M4, the roll gap change value detected by the position detection unit is M5 (a positive value or a negative value), the measured wear amount of the floating grinding roller 12 is M6 (a negative value), and the measured wear amount of the fixed grinding roller 14 is M7 (a negative value), so that the corrected roll gap value M8 should be M4+M5−M6−M7.

Methods for measuring the wear value of each grinding roller include, but are not limited to, detection performed by means of a sensor, periodic detection performed by means of a dedicated instrument, or estimation performed according to empirical values.

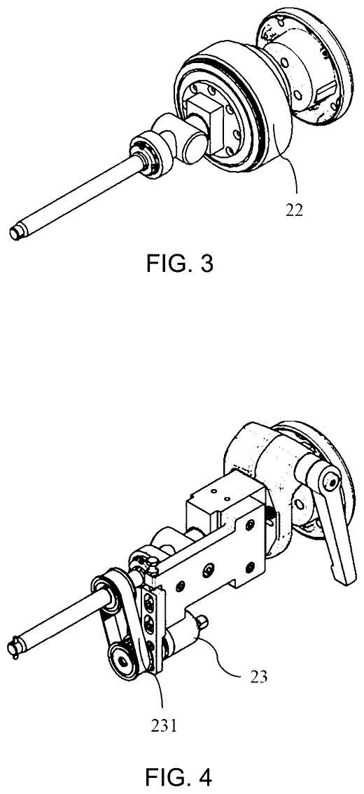

In an optional embodiment, FIG. 3 to FIG. 7 respectively show a second position detection unit 22, a third position detection unit 23, a fourth position detection unit 24, a fifth position detection unit 25, and a sixth position detection unit 26 according to different embodiments.

In Embodiment 2, referring to FIG. 3, the second position detection unit 22 is directly mounted at a middle portion of the adjusting screw rod. Further, the adjusting screw rod passes through the second position detection unit 22, and is connected to the hand wheel.

In Embodiment 3, referring to FIG. 4, the third position detection unit 23 is connected to the adjusting screw rod by means of a belt transmission mechanism 231. The belt transmission mechanism rotates in synchronization with the adjusting screw rod, so as to synchronize the rotation change of the adjusting screw rod to the third position detection unit 23.

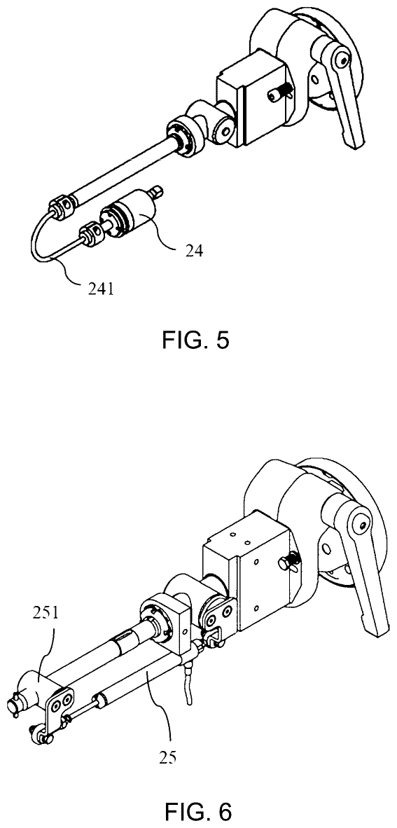

In Embodiment 1, referring back to FIG. 2, the first position detection unit 21 is directly provided at either one of two ends of the adjusting screw rod. Specifically, one end of the adjusting screw rod is a driving end, and the other end is a following end. The driving end is closer to the hand wheel or a motor. The following end is closer to the transmission mechanism (e.g., the connecting rod 16) connected to the roll gap adjusting mechanism 20. In the embodiments of the present invention, the hand wheel and the first position detection unit 21 are respectively provided at opposite ends of the adjusting screw rod. Further, in Embodiment 4, referring to FIG. 5, the fourth position detection unit 24 is connected to the end of the adjusting screw rod by means of a flexible shaft 241. Alternatively, the fourth position detection unit 24 is connected to the end of the adjusting screw rod by means of a direction changing coupling. Compared with directly providing the first position detection unit 21 at the end of the adjusting screw rod, the arrangement of the fourth position detection unit 24 provides a more flexible spatial layout so as to be adapted to spatial arrangement inside the flour mill.

In Embodiment 5, referring to FIG. 6, the fifth position detection unit 25 is connected to the adjusting screw rod by means of a nut 251. The nut 251 translates along the adjusting screw rod as the adjusting screw rod rotates. The fifth position detection unit 25 detects a translation change of the nut 251 to detect the rotation change of the adjusting screw rod.

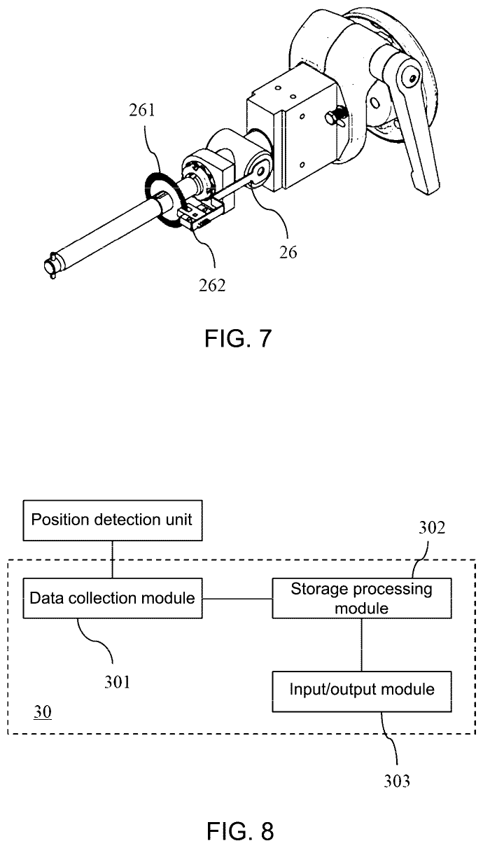

In Embodiment 6, referring to FIG. 7, the sixth position detection unit 26 includes a sensing ring 261 and a sensing arm 262. The sensing ring 261 rotates in synchronization with the adjusting screw rod, and the sensing arm 262 is used to detect rotation of the sensing ring 261.

Different types of position detection units are disclosed above, but the present invention is not limited to the position detection units in the specific embodiments. It should be understood that the position detection units include, but are not limited to, an encoder, a displacement sensor, a laser range finder, an ultrasonic sensor, and a photoelectric switch. Different types of position detection units having different adaptive mechanical structures may be selected according to comprehensive considerations in terms of restrictions on the spatial layout, installation difficulty, cost control, etc.

In the embodiments of the present invention, the adjusting screw rod driven by the hand wheel is described, and the arrangement of the position detection unit thereof is also applicable to the adjusting screw rod driven by the motor. Regardless of whether the adjusting screw rod is driven by the hand wheel or the motor, the present invention provides the position detection unit directly or indirectly connected to the adjusting screw rod, and the position detection unit can be used in manufacture of new flour mills, and can also be used in upgrading of flour mills having been put into use.

It should be understood that the embodiments shown in the drawings merely show optional shapes, sizes, and arrangements of each optional component of the product of the present invention, but are only illustrative rather than restrictive, and other shapes, sizes, and arrangements may also be adopted without departing from the spirit and scope of the present invention.

Although the technical contents and the technical features of the present invention have been disclosed above, it should be understood that those skilled in the art can make various changes and improvements to the above-disclosed idea under the inventive concept of the present invention, all of which fall within the scope of protection of the present invention. The above description of the embodiments is illustrative rather than restrictive, and the scope of protection of the present invention is defined by the claims.

1. A monitoring method for a roll gap between grinding rollers of a flour mill, comprising:
providing a control unit and a roll gap adjusting mechanism,
the control unit having a data collection module and a storage processing module, and a roll gap initial value being preset in the storage processing module;
the roll gap adjusting mechanism at least comprising an adjusting screw rod and a position detection unit, and the position detection unit detecting a rotation change of the adjusting screw rod and sending position detection data to the data collection module;
the data collection module converting the position detection data into a roll gap change value and sending the roll gap change value to the storage processing module, and the storage processing module obtaining a current roll gap value according to the roll gap initial value and the roll gap change value, and storing the roll gap change value and the current roll gap value in real time.

2. The monitoring method for a roll gap between grinding rollers of a flour mill according to claim 1, wherein the control unit further has an input/output module, and the input/output module communicates with the storage processing module to set or read data in the storage processing module.

3. The monitoring method for a roll gap between grinding rollers of a flour mill according to claim 2, wherein the input/output module comprises a display, and the display displays the roll gap change value and the current roll gap value in real time.

4. The monitoring method for a roll gap between grinding rollers of a flour mill according to claim 1, wherein the position detection unit detects the rotation change of the adjusting screw rod during power-on and power-off of the flour mill.

5. The monitoring method for a roll gap between grinding rollers of a flour mill according to claim 2, further comprising: after the flour mill operates for each cycle, measuring a wear value of each grinding roller, and setting the wear value in the storage processing module by means of the input/output module, so that the storage processing module obtains a corrected roll gap value according to the current roll gap value and the wear value.

6. The monitoring method for a roll gap between grinding rollers of a flour mill according to claim 1, wherein the position detection unit is directly mounted at a middle portion of the adjusting screw rod.

7. The monitoring method for a roll gap between grinding rollers of a flour mill according to claim 1, wherein the position detection unit is connected to the adjusting screw rod by means of a belt transmission mechanism, and the belt transmission mechanism rotates in synchronization with the adjusting screw rod.

8. The monitoring method for a roll gap between grinding rollers of a flour mill according to claim 1, wherein the position detection unit is provided at either one of two ends of the adjusting screw rod.

9. The monitoring method for a roll gap between grinding rollers of a flour mill according to claim 8, wherein the position detection unit is connected to the end of the adjusting screw rod by means of a direction changing coupling or a flexible shaft.

10. The monitoring method for a roll gap between grinding rollers of a flour mill according to claim 1, wherein the position detection unit is connected to the adjusting screw rod by means of a nut, and the nut translates along the adjusting screw rod as the adjusting screw rod rotates.

11. The monitoring method for a roll gap between grinding rollers of a flour mill according to claim 1, wherein the position detection unit comprises a sensing ring and a sensing arm, the sensing ring rotating in synchronization with the adjusting screw rod, and the sensing arm being used to detect rotation of the sensing ring.
